(19) United States
(12) Patent Application Publication
(10) Pub. No.: US 2026/0240148 A1
(43) Pub. Date: Aug. 20, 2026

(54) THERMOPLASTIC VULCANIZATE, PREPARATION METHOD THEREOF, AND APPLICATION THEREOF

(71) Applicant: Guangzhou Power Supply Bureau of Guangdong Power Grid Co., Ltd., Guangzhou (CN)

(72) Inventors: Jiasheng HUANG, Guangzhou (CN); Zhuozhan HAN, Guangzhou (CN); Ying LING, Guangzhou (CN); Meng LI, Guangzhou (CN)

(73) Assignee: Guangzhou Power Supply Bureau of Guangdong Power Grid Co., Ltd., Guangzhou (CN)

(21) Appl. No.: 19/333,983

(22) Filed: Sep. 19, 2025

(30) Foreign Application Priority Data
Feb. 18, 2025 (CN) 202510175493.0

(51) Int. Cl. A01N 25/10; A01N 25/22; A01N 43/16; A01N 43/50; A01N 43/56; A01N 43/86; A01N 53/00; A01N 57/16; A01P 7/04; A01P 17/00

(52) U.S. Cl. CPC A01N 25/10; A01N 25/22; A01N 43/16; A01N 43/50; A01N 43/56; A01N 43/86; A01N 53/00; A01N 57/16; A01P 7/04; A01P 17/00

(57) ABSTRACT

A thermoplastic vulcanizate, a preparation method thereof, and an application thereof are provided. The thermoplastic vulcanizate includes the following raw materials in parts by weight: 8 parts to 40 parts of a heat-resistant rubber, 60 parts to 90 parts of a plastic, 1 part to 6 parts of an ant-repellent agent, and 0.1 parts to 3 parts of a vulcanizing agent. The application provides a drug-aggregated thermoplastic vulcanizate in which the cross-linked rubber acts as a “island” phase and the plastic acts as a “sea” phase, with the pesticide being predominantly aggregated in the dispersed rubber phase.

### RELATED APPLICATIONS

This application claims priority to Chinese patent application No. 202510175493.0, entitled “THERMOPLASTIC VULCANIZATE, PREPARATION METHOD THEREOF, AND APPLICATION THEREOF” filed on Feb. 18, 2025, the content of which is hereby incorporated by reference in its entirety.

### TECHNICAL FIELD

The present application relates to the technical field of vulcanized rubber, particularly to a thermoplastic vulcanizate, a preparation method thereof, and an application thereof.

### BACKGROUND

Thermoplastic vulcanizates are a class of polymer materials that combine the elasticity of rubber with the processing characteristics of thermoplastic plastics. From the perspective of material development, conventional rubber materials offer excellent elasticity and flexibility, but the processing is complex, typically requiring irreversible chemical reactions such as vulcanization and cross-linking, and these conventional rubber materials are difficult to recycle. Thermoplastic plastics are easy to process and recyclable, yet they lack the superior toughness and tactile feel of rubber. The emergence of thermoplastic vulcanizates bridged the gap between rubber and thermoplastic plastics. Additionally, thermoplastic vulcanizates exhibit excellent processability. They can be rapidly molded using conventional processing methods such as injection molding, extrusion, and blow molding, just like thermoplastic plastics, significantly shortening production cycles and improving production efficiency. Moreover, the recyclability of thermoplastic vulcanizates endows them with a significant advantage in resource recycling. Against the backdrop of global advocacy for sustainable development, this characteristic makes them more competitive in the market.

Thermoplastic vulcanizates are widely used in construction, wire and cable, sports equipment, and other industries. For example, thermoplastic vulcanizates can be used to manufacture thermal insulation materials including thermal insulation boards and thermal insulation pipes. Thermoplastic vulcanizates can also be used to form both the insulation layers and sheathing layers of wires and cables. When used as cable materials, thermoplastic vulcanizates are in long-term contact with underground soil, and therefore, they must resist pests while maintaining their functional performance. To ensure long-term, effective resistance to pests for cable materials, pesticides are typically added into these cable materials during production. However, the cable materials directly mixed with pesticides suffer from rapid drug loss, resulting in a short service life. In recent years, microencapsulated pesticides can reduce the impact of the external environment on the pesticides, as well as to minimize volatilization, decomposition, and loss of pesticides. However, microencapsulating pesticides before incorporating them into cable materials not only adds extra preparation process but also markedly raises production costs.

### SUMMARY

In view of the above, objectives of the present application include providing a drug-aggregated thermoplastic vulcanizate that exhibits a stable property, enables long-lasting effectiveness of ant-repellent agents or the like, and has a simple preparation process that lowers production costs and shortens preparation time.

The technical solutions of the present application are as follows:

A first aspect of the present application provides a thermoplastic vulcanizate, including following raw materials in parts by weight: 8 parts to 40 parts of a heat-resistant rubber, 60 parts to 90 parts of a plastic, 1 part to 6 parts of an ant-repellent agent, and 0.1 parts to 3 parts of a vulcanizing agent.

In an embodiment, the heat-resistant rubber is selected from the group consisting of ethylene-vinyl acetate rubber, silicone rubber, acrylate rubber, hydrogenated acrylonitrile-butadiene rubber, acrylonitrile-butadiene rubber, chlorinated polyethylene rubber, ethylene-propylene-diene rubber, and any combination thereof.

In an embodiment, the plastic is selected from the group consisting of high-density polyethylene, low-density polyethylene, polypropylene, polyvinylidene fluoride, polyvinyl chloride, and any combination thereof.

In an embodiment, the ant-repellent agent is selected from the group consisting of imidacloprid, bifenthrin, abamectin, thiamethoxam, cypermethrin, chlorpyrifos, fipronil, and any combination thereof.

In an embodiment, the vulcanizing agent is selected from the group consisting of dicumyl peroxide, 2,5-dimethyl-2,5-di(tert-butylperoxy)hexane, sulfur, silane coupling agent, trithiocyanuric acid, 2,4-dichlorobenzoyl peroxide, tert-butyl peroxybenzoate, and any combination thereof.

In an embodiment, the thermoplastic vulcanizate further includes an antioxidant, an anti-aging agent, or a combination of the antioxidant and the anti-aging agent.

In an embodiment, the thermoplastic vulcanizate includes the following raw materials in parts by weight: 8 parts to 40 parts of the heat-resistant rubber, 60 parts to 90 parts of the plastic, 1 part to 6 parts of the ant-repellent agent, 0.1 parts to 3 parts of the vulcanizing agent, 0.1 parts to 0.5 parts of the antioxidant, and 0.5 parts to 1 part of the anti-aging agent.

In an embodiment, the antioxidant is selected from the group consisting of antioxidant 1010, antioxidant 264, antioxidant 168, antioxidant 1067, and any combination thereof.

In an embodiment, the anti-aging agent is selected from the group consisting of anti-aging agent 4010NA, anti-aging agent ODA, anti-aging agent 264, and any combination thereof.

A second aspect of the present application provides a method for preparing the thermoplastic vulcanizate as described above, including following steps:
mixing the heat-resistant rubber, the ant-repellent agent, and the vulcanizing agent to obtain a premix;
blending the premix with the plastic to obtain a rubber-plastic mixture; and
subjecting the rubber-plastic mixture to dynamic vulcanization.

In an embodiment, the dynamic vulcanization satisfies at least one of the following conditions:
(1) a temperature is in a range from 160° C. to 230° C.;
(2) a rotation speed is in a range from 30 rpm to 90 rpm; and
(3) a time period is in a range from 5 minutes to 10 minutes.

A third aspect of the present application provides an insect-repellent and insecticidal chemical product, including the thermoplastic vulcanizate as a raw material.

A fourth aspect of the present application provides a cable, including a cable body and the insect-repellent and insecticidal chemical product adhered to a surface of the cable body.

Compared with the prior art, the present application has the following beneficial effects:

The present application provides a drug-aggregated thermoplastic vulcanizate, in which the cross-linked rubber acts as an “island” phase and the plastic acts as a “sea” phase, with the pesticide is predominantly aggregated within the dispersed rubber phase. The drug-aggregated thermoplastic vulcanizate exhibits stable properties. By means of the good compatibility between the rubber and the pesticide, the pesticide is mostly aggregated in the dispersed rubber phase through rapid shear and cross-linking of the rubber during processing. Encapsulating the pesticide in the dispersed phase of the thermoplastic vulcanizate can effectively suppress the volatilization, decomposition, oxidation, and loss of the pesticide in the environment, allowing long-lasting effectiveness of the pesticide, thereby improving the utilization efficiency of the pesticide.

In addition, the present application utilizes rubber-plastic blending and dynamic vulcanization to provide a method for preparing the drug-aggregated thermoplastic vulcanizate. The preparation method is simple and can reduce production costs and shorten preparation time. The method provides a distinctive and simple processing approach to encapsulate the pesticide, effectively improving the thermal stability and prolonging the service life of the pesticide within the thermoplastic vulcanizate material. The method offers great industrial practical value in the field of integrated production of polymer materials. Compared to directly adding microencapsulated pesticides into the matrix, this method eliminates the step of pesticide microencapsulation, greatly reducing costs. Moreover, this method is suitable for large-scale industrial production, offering substantial application value in practical industrial production.

### BRIEF DESCRIPTION OF THE DRAWINGS

To illustrate the technical solutions in the embodiments of the present application or in the prior art more clearly, the accompanying drawings for describing the embodiments or the prior art are introduced briefly. Apparently, the following described drawings are merely for the embodiments of the present application, and other drawings can be derived based on these drawings by those of ordinary skill in the art without any creative effort.

FIG. 1A shows a scanning electron microscopy (SEM) image of a thermoplastic vulcanizate prepared in Example 1.

FIG. 1B shows an energy-dispersive X-ray spectroscopy (EDS) mapping of the thermoplastic vulcanizate prepared in Example 1.

FIG. 2 shows a thermogravimetric curve diagram of the thermoplastic vulcanizate prepared in Example 1 and raw materials used.

FIG. 3A shows an SEM image of a thermoplastic vulcanizate prepared in Example 4.

FIG. 3B shows an EDS mapping of the thermoplastic vulcanizate prepared in Example 4.

FIG. 4 shows a thermogravimetric curve diagram of the thermoplastic vulcanizate prepared in Example 4 and raw materials used.

FIG. 5A shows an SEM image of a composite material prepared in Comparative Example 1.

FIG. 5B shows an EDS mapping of the composite material prepared in Comparative Example 1.

FIG. 6A shows an SEM image of a composite material prepared in Comparative Example 2.

FIG. 6B shows an EDS mapping of the composite material prepared in Comparative Example 2.

### DETAILED DESCRIPTION

The specific embodiments of the present application will be described in detail in order to make the objectives, features, and advantages of the present application more apparent and understandable. Many specific details are disclosed in the following description to facilitate a comprehensive understanding of the present application. However, the present application can be implemented in various ways different from those described herein, and those skilled in the art may make similar improvements without departing from the concept of the present application. Therefore, the present application is not limited to the specific embodiments disclosed below.

Unless defined otherwise, all technical and scientific terms used herein have the same meaning as commonly understood by those skilled in the art to which the present application belongs. The terms used in the specification of the present application are only for the purpose of describing exemplary examples and are not intended to limit the present application.

Unless otherwise stated or there is a contradiction, terms or phrases used in the present application have the following meanings.

As used herein, “one or more” refers to any one, any two, or any two or more of the listed items.

As used herein, the terms “and/or”, “or/and”, and “as well as/or” mean that their optional ranges include any one of two or more relevant listed items, as well as any or all combinations of the relevant listed items. The any or all combinations include combinations of any two of the relevant listed items, combinations of any more of the relevant listed items, or combinations of all of the relevant listed items. It should be understood that when at least three items are connected with the combination of at least two conjunctions selected from “and/or”, “or/and” and “as well as/or”, in the present application, the technical solution undoubtedly includes technical solutions that are all connected by “logical AND” and also undoubtedly includes technical solutions that are all connected by “logical OR”. For example, “A and/or B” includes three parallel solutions, i.e., A, B, and a combination of A and B. For example, the technical solution of “A, and/or, B, and/or, C, and/or, D” includes any one of A, B, C, and D (i.e., technical solutions connected by “logical OR”); as well as any or all combinations of A, B, C, and D, that is, including combinations of any two or three of A, B, C, and D, and also the combination of A, B, C, and D (i.e., technical solutions connected by “logical AND”).

As used herein, the terms “further”, “furthermore”, “specially”, etc., are for descriptive purposes, indicating the differences in content, but cannot be understood as a limitation on the protection scope of the present application.

As used herein, the terms “first aspect,” “second aspect,” “third aspect,” and “fourth aspect” are used solely for descriptive purposes, and are not to be construed as indicating or implying relative importance or quantity, or as implicitly specifying the importance or quantity of the technical features indicated. In addition, “first”, “second”, “third”, “fourth” and the like only serve the purpose of non-exhaustive enumeration, and it should be understood that they do not constitute a closed-ended limitation on the quantity. Thus, the quantity of the feature defined with “first” or “second” may explicitly or implicitly be at least one. In the description of the present application, “a plurality of” means at least two, such as two, three, unless otherwise defined explicitly and specifically. In the description of the present application, the term “several” means at least one, such as one, two, unless otherwise defined explicitly and specifically.

In the present application, when a numerical interval (i.e., a numerical range) is mentioned, unless otherwise specified, suitable values are considered as being continuously distributed within the numerical interval, and includes the minimum value and the maximum value, as well as every value between the minimum value and the maximum value. Furthermore, when the numerical interval refers to integers in the numerical interval, every integer between the minimum value and the maximum value is included. Additionally, when multiple numerical ranges are provided to describe a feature or characteristic, these numerical ranges can be combined. In other words, unless otherwise indicated, the numerical ranges disclosed in the present application should be understood to encompass any and all subranges included therein.

The present application specifically discloses only some numerical ranges. However, any lower limit can be combined with any upper limit to form a range not expressly stated, any lower limit can be combined with any other lower limit to form a range not expressly stated, and similarly any upper limit can be combined with any other upper limit to form a range not expressly stated. In addition, each individually disclosed point or individual single numerical value may itself be a lower limit or an upper limit which can be combined with any other point or individual numerical value or combined with another lower limit or upper limit to form a range not expressly stated. The numerical range expressed with endpoints includes all numbers within that range as well as any subranges within that range. For example, the range of 1 to 5 includes 1, 1.1, 1.3, 1.5, 2, 2.75, 3, 3.80, 4, 5, etc.

In the present application, when an amount in percentage is mentioned, unless otherwise specifically stated, it refers to a mass percentage for both a solid-liquid mixture and a solid-solid mixture, and refers to a volume percentage for a liquid-liquid mixture.

In the present application, when a concentration in percentage is mentioned, unless otherwise specifically stated, it always refers to a final concentration, referring to a proportion of the added component in a system after adding that component.

In the present application, when a temperature parameter is mentioned, unless otherwise specifically stated, not only a thermostatic process but also variations within a certain temperature interval is allowed. The thermostatic process allows the temperature to fluctuate within the precision of the instrument control. Fluctuations within ranges such as ±5° C., ±2° C., ±1° C., ±0.5° C., ±0.4° C., ±0.3° C., ±0.2° C., or ±0.1° C. are permitted. In the present application, the terms “ambient temperature” and “room temperature” refer to conditions in the absence of temperature control, and are typically in a range from 4° C. to 35° C., preferably 20±5 ° C.

In the present application, among the technical features described in an open-ended manner, a closed-end technical solution consisting of the listed features is included, as well as an open-ended technical solution including the listed features is also included.

Thermoplastic vulcanizate is a special type of thermoplastic elastomer obtained through dynamic vulcanization processing technology. When a small amount of plastic phase is melt-blended with a large amount of rubber, the rubber is subjected to chemical cross-linking under the action of a vulcanizing agent, resulting in increased viscosity. Consequently, under high-temperature mechanical shear, the rubber-plastic blend undergoes phase inversion, where a large amount of rubber phase breaks into micron-sized particles and then is uniformly dispersed within the small amount of plastic phase, forming a unique sea-island structure after cross-linking of the rubber. This unique structure endows the thermoplastic vulcanizate with both the high elasticity and softness of conventional rubber and the thermoplastic processability and recyclability of plastics, enabling the thermoplastic vulcanizate to gradually replace conventional thermosetting rubber.

In recent years, microencapsulating pesticides can reduce the impact of the external environment on the pesticides, as well as minimize volatilization, decomposition, and loss of the pesticides. However, microencapsulating pesticides before incorporating them into cable materials not only adds extra preparation process but also markedly raises production costs. In view of this, after extensive studies, the researchers of the present application unexpectedly discovered a thermoplastic vulcanizate composition, in which rubber and plastic form a “sea-island” structure, and the pesticide is aggregated in the island phase structure of the thermoplastic vulcanizate through dynamic vulcanization and cross-linking by means of the good compatibility between the pesticide and the rubber phase, thereby forming a thermoplastic vulcanizate with the pesticide as the core and the island phase material as the shell.

A first aspect of the present application provides a thermoplastic vulcanizate, including following raw materials in parts by weight: 8 parts to 40 parts of a heat-resistant rubber, 60 parts to 90 parts of a plastic, 1 part to 6 parts of an ant-repellent agent, and 0.1 parts to 3 parts of a vulcanizing agent.

In some embodiments, the heat-resistant rubber is selected from the group consisting of ethylene-vinyl acetate rubber, silicone rubber, acrylate rubber, hydrogenated acrylonitrile-butadiene rubber, acrylonitrile-butadiene rubber, chlorinated polyethylene rubber, ethylene-propylene-diene rubber, and any combination thereof. Further, the heat-resistant rubber is ethylene-vinyl acetate rubber, acrylate rubber, or hydrogenated acrylonitrile-butadiene rubber. Specifically, a vinyl acetate (VA) content in the ethylene-vinyl acetate rubber is in a range from 18% to 80%. The higher the VA content, the greater the polar interaction between molecular chains, resulting in better heat resistance. In the hydrogenated acrylonitrile-butadiene rubber, the double bond content is in a range from 1% to 5%, and the acrylonitrile content is in a range from 30% to 70%. A higher acrylonitrile content can increase the polar interaction between molecular chains, and the increased interaction between molecular chains can significantly improve the thermal stability. The double bond content of hydrogenated acrylonitrile-butadiene rubber can affect its thermal stability, and a higher double bond content can reduce the thermal stability. Therefore, controlling the double bond content and acrylonitrile content within the above ranges is conducive to ensuring good thermal stability. In the same region, the island phase of silicone rubber in the SEM image is more than the chlorine-aggregated area in the EDS mapping, revealing that part of imidacloprid (IMI) is wrapped with the island phase of silicone rubber while another part of IMI diffuses into the high density polyethylene (HDPE) matrix.

In some embodiments, the plastic is selected from the group consisting of high-density polyethylene, low-density polyethylene, polypropylene, polyvinylidene fluoride, polyvinyl chloride, and any combination thereof.

In some embodiments, the ant-repellent agent is selected from the group consisting of imidacloprid, bifenthrin, abamectin, thiamethoxam, cypermethrin, chlorpyrifos, fipronil, and any combination thereof. The ant-repellent agent has good compatibility with rubber and can improve the stability of the prepared thermoplastic vulcanizate.

In some embodiments, the vulcanizing agent is selected from the group consisting of dicumyl peroxide, 2,5-dimethyl-2,5-di(tert-butylperoxy)hexane, sulfur, silane coupling agent, trithiocyanuric acid, 2,4-dichlorobenzoyl peroxide, tert-butyl peroxybenzoate, and any combination thereof. Further, the vulcanizing agent is dicumyl peroxide, or tert-butyl peroxybenzoate.

In some embodiments, the thermoplastic vulcanizate further includes an antioxidant, an anti-aging agent, or a combination of the antioxidant and the anti-aging agent.

In some embodiments, the thermoplastic vulcanizate includes the following raw materials in parts by weight: 8 parts to 40 parts of the heat-resistant rubber, 60 parts to 90 parts of the plastic, 1 part to 6 parts of the ant-repellent agent, 0.1 parts to 3 parts of the vulcanizing agent, 0.1 parts to 0.5 parts of the antioxidant, and 0.5 parts to 1 part of the anti-aging agent.

In some embodiment, the antioxidant is selected from the group consisting of antioxidant 1010, antioxidant 264, antioxidant 168, antioxidant 1067, and any combination thereof.

In some embodiments, the anti-aging agent is selected from the group consisting of anti-aging agent 4010NA, anti-aging agent ODA, anti-aging agent 264, and any combination thereof. Specifically, anti-aging agent 4010NA is N-isopropyl-N′-phenyl-p-phenylenediamine, anti-aging agent ODA is octylated diphenylamine, and anti-aging agent 264 is 2,6-di-tert-butyl-4-methylphenol, which can be selected by those skilled in the art according to actual circumstances.

It should be understood that, the thermoplastic vulcanizate can also include other additives commonly used in the industry as needed as raw materials, such as plasticizers, calcium carbonate, montmorillonite, color masterbatch, etc., which can be added in conventional amounts by those skilled in the art according to actual needs. Optionally, the plasticizer is at least one of dioctyl sebacate, triphenyl phosphate, epoxidized soybean oil, diisononyl phthalate, dioctyl phthalate, paraffinic oil, or naphthenic oil.

A second aspect of the present application provides a method for preparing the thermoplastic vulcanizate as described above, including the following steps:
mixing the heat-resistant rubber, the ant-repellent agent, and the vulcanizing agent to obtain a premix;
blending the premix with the plastic to obtain a rubber-plastic mixture; and
subjecting the rubber-plastic mixture to dynamic vulcanization.

In some embodiments, the method for preparing the thermoplastic vulcanizate as described above, including the following steps:
mixing the heat-resistant rubber, the ant-repellent agent, and the vulcanizing agent to obtain a premix;
blending the premix, the plastic, the antioxidant, and the anti-aging agent to obtain a rubber-plastic mixture; and
subjecting the rubber-plastic mixture to dynamic vulcanization.

In some embodiments, the method for preparing the thermoplastic vulcanizate as described above, including the following steps:
(1) pre-mixing rubber and ant-repellent agent: uniformly mixing the rubber, the ant-repellent agent, and the vulcanizing agent in an internal mixer at a relatively low temperature, such as a temperature lower than a cross-linking temperature of the rubber, then cooling to room temperature, obtaining a premix;
(2) uniformly mixing the premix obtained in step (1) with the plasticizer, the plastic, the antioxidant, and the anti-aging agent in a formula to obtain a rubber-plastic mixture; and
(3) dynamic vulcanization: subjecting the rubber-plastic mixture obtained in step (2) to shear vulcanization using a torque rheometer under conditions including a temperature controlled within a range from 160° C. to 230° C., a rotation speed within a range from 30 rpm to 90 rpm, and a time period within a range from 5 minutes to 10 minutes.

In some embodiments, the conditions for dynamic vulcanization include: the temperature ranging from 160° C. to 230° C. It should be understood that the temperature for dynamic vulcanization includes but is not limited to 160° C., 170° C., 180° C., 190° C., 200° C., 210° C., 220° C., or 230° C.

In some embodiments, the conditions for dynamic vulcanization include: the rotation speed ranging from 30 rpm to 90 rpm. It should be understood that the rotation speed for dynamic vulcanization includes but is not limited to 30 rpm, 40 rpm, 50 rpm, 60 rpm, 70 rpm, 80 rpm, or 90 rpm.

In some embodiments, the conditions for dynamic vulcanization include: the time period ranging from 5 minutes (min) to 10 min. It should be understood that the time period for dynamic vulcanization includes but is not limited to 5 min, 6 min, 7 min, 8 min, 9 min, or 10 min.

A third aspect of the present application provides an insect-repellent and insecticidal chemical product, including the thermoplastic vulcanizate as a raw material.

A fourth aspect of the present application provides a cable, including a cable body and the insect-repellent and insecticidal chemical product adhered to a surface of the cable body.

The following provides further explanation in conjunction with specific examples. Unless otherwise specified, all raw materials involved in the following examples are commercially available; all instruments used are commercially available unless otherwise stated; and all processes involved are conventional choices made by those skilled in the art unless otherwise specified.

The specific examples are as follows.

### EXAMPLE 1

Raw materials used in this example had the following basic composition in parts by weight: 16 parts by weight of ethylene-vinyl acetate rubber (EVA), 80 parts by weight of high-density polyethylene (HDPE), 4 parts by weight of imidacloprid (IMI), 0.16 parts by weight of dicumyl peroxide, 0.5 parts by weight of antioxidant 1010, and 1 part by weight of anti-aging agent 4010NA, where the vinyl acetate (VA) content in the ethylene-vinyl acetate rubber was 26%.

A method for preparing a drug-aggregated thermoplastic vulcanizate was as follows:
(1) Ethylene-vinyl acetate rubber, dicumyl peroxide, and imidacloprid were preliminarily pre-mixed using an internal mixer under a temperature of 100° C. and a rotation speed of 60 rpm for a time period of 6 minutes to obtain a premix.
(2) The premix obtained in step (1) was uniformly mixed with high-density polyethylene, antioxidant 1010, and anti-aging agent 4010NA at room temperature to obtain a rubber-plastic mixture.
(3) Dynamic vulcanization: The rubber-plastic mixture obtained in step (2) was subjected to shear vulcanization using a torque rheometer under a temperature of 190° C. and a rotation speed of 60 rpm for a time period of 10 minutes.

### EXAMPLE 2

This example differs from Example 1 mainly in the amounts of the raw materials as follows: 8 parts by weight of ethylene-vinyl acetate rubber (EVA), 90 parts by weight of high-density polyethylene (HDPE), 2 parts by weight of imidacloprid (IMI), 0.08 parts by weight of dicumyl peroxide, 0.5 parts by weight of antioxidant 1010, and 1 part by weight of anti-aging agent 4010NA, where the vinyl acetate (VA) content in the ethylene-vinyl acetate rubber was 26%.

### EXAMPLE 3

This example differs from Example 1 mainly in the amounts of the raw materials as follows: 24 parts by weight of ethylene-vinyl acetate rubber (EVA), 70 parts by weight of high-density polyethylene (HDPE), 6 parts by weight of imidacloprid (IMI), 0.24 parts by weight of dicumyl peroxide, 0.5 parts by weight of antioxidant 1010, and 1 part by weight of anti-aging agent 4010NA, where the vinyl acetate (VA) content in the ethylene-vinyl acetate rubber was 26%.

### EXAMPLE 4

Raw materials used in this example had the following basic composition in parts by weight: 16 parts by weight of silicone rubber, 80 parts by weight of high-density polyethylene (HDPE), 4 parts by weight of imidacloprid (IMI), 0.8 parts by weight of dicumyl peroxide, 0.5 parts by weight of antioxidant 1010, and 1 part by weight of anti-aging agent 4010NA.

A method for preparing a drug-aggregated thermoplastic vulcanizate was as follows:
(1) Silicone rubber, dicumyl peroxide, and imidacloprid were preliminarily pre-mixed using an internal mixer under a temperature of 100° C. and a rotation speed of 60 rpm for a time period of 6 minutes to obtain a premix.
(2) The premix obtained in step (1) was uniformly mixed with high-density polyethylene, antioxidant 1010, and anti-aging agent 4010NA at room temperature to obtain a rubber-plastic mixture.
(3) Dynamic vulcanization: The rubber-plastic mixture obtained in step (2) was subjected to shear vulcanization using a torque rheometer under a temperature of 190° C. and a rotation speed of 60 rpm for a time period of 10 minutes.

### EXAMPLE 5

Raw materials used in this example had the following basic composition in parts by weight: 8 parts by weight of silicone rubber, 90 parts by weight of high-density polyethylene (HDPE), 2 parts by weight of imidacloprid (IMI), 0.4 parts by weight of dicumyl peroxide, 0.5 parts by weight of antioxidant 1010, and 1 part by weight of anti-aging agent 4010NA.

A method for preparing a drug-aggregated thermoplastic vulcanizate was as follows:
(1) Silicone rubber, dicumyl peroxide, and imidacloprid were preliminarily pre-mixed using an internal mixer under a temperature of 100° C. and a rotation speed of 60 rpm for a time period of 6 minutes to obtain a premix.
(2) The premix obtained in step (1) was uniformly mixed with high-density polyethylene, antioxidant 1010, and anti-aging agent 4010NA at room temperature to obtain a rubber-plastic mixture.
(3) Dynamic vulcanization: The rubber-plastic mixture obtained in step (2) was subjected to shear vulcanization using a torque rheometer under a temperature of 190° C. and a rotation speed of 60 rpm for a time period of 10 minutes.

### EXAMPLE 6

Raw materials used in this example had the following basic composition in parts by weight: 16 parts by weight of acrylate rubber, 80 parts by weight of high-density polyethylene (HDPE), 4 parts by weight of imidacloprid (IMI), 0.48 parts by weight of tert-butyl peroxybenzoate, 0.5 parts by weight of antioxidant 1010, and 1 part by weight of anti-aging agent 4010NA.

A method for preparing a drug-aggregated thermoplastic vulcanizate was as follows:
(1) Acrylate rubber, tert-butyl peroxybenzoate, and imidacloprid were preliminarily pre-mixed using an internal mixer under a temperature of 100° C. and a rotation speed of 60 rpm for a time period of 6 minutes to obtain a premix.
(2) The premix obtained in step (1) was uniformly mixed with high-density polyethylene, antioxidant 1010, and anti-aging agent 4010NA at room temperature to obtain a rubber-plastic mixture.
(3) Dynamic vulcanization: The rubber-plastic mixture obtained in step (2) was subjected to shear vulcanization using a torque rheometer under a temperature of 190° C. and a rotation speed of 60 rpm for a time period of 10 minutes.

### COMPARATIVE EXAMPLE 1

Raw materials used in this comparative example had the following basic composition in parts by weight: 96 parts by weight of high-density polyethylene (HDPE), 4 parts by weight of imidacloprid (IMI), 0.5 parts by weight of antioxidant 1010, and 1 part by weight of anti-aging agent 4010NA.

The preparation method was as follows:

Imidacloprid, high-density polyethylene, antioxidant 1010, and anti-aging agent 4010NA were uniformly mixed directly in a torque rheometer under a temperature of 180° C. and a rotation speed of 60 rpm for a time period of 8 minutes to obtain an IMI/HDPE composite material.

### COMPARATIVE EXAMPLE 2

Comparative Example 2 was substantially the same as Example 1, only with the difference in that: no vulcanizing agent was added in Comparative Example 2.

### COMPARATIVE EXAMPLE 3

Comparative Example 3 was substantially the same as Example 1, only with the difference in that: the ethylene-vinyl acetate rubber was replaced with silicone rubber (i.e., methyl vinyl silicone rubber), and the high-density polyethylene was replaced with polypropylene.

The thermoplastic vulcanizates prepared in Examples and Comparative Examples were subjected to following performance testing:
(1) Microscopic morphology test: To observe the microscopic morphologies of the prepared drug-aggregated thermoplastic vulcanizates, field emission scanning electron microscope (SEM, Inspect-F, FEI, Finland) was used at an acceleration voltage of 5 kV to observe the drug-aggregated thermoplastic vulcanizates.
(2) Thermogravimetric curves of IMI, IMI/HDPE, and IMI/EVA/HDPE were measured to verify that the thermal stability of IMI after encapsulated with EVA was improved.

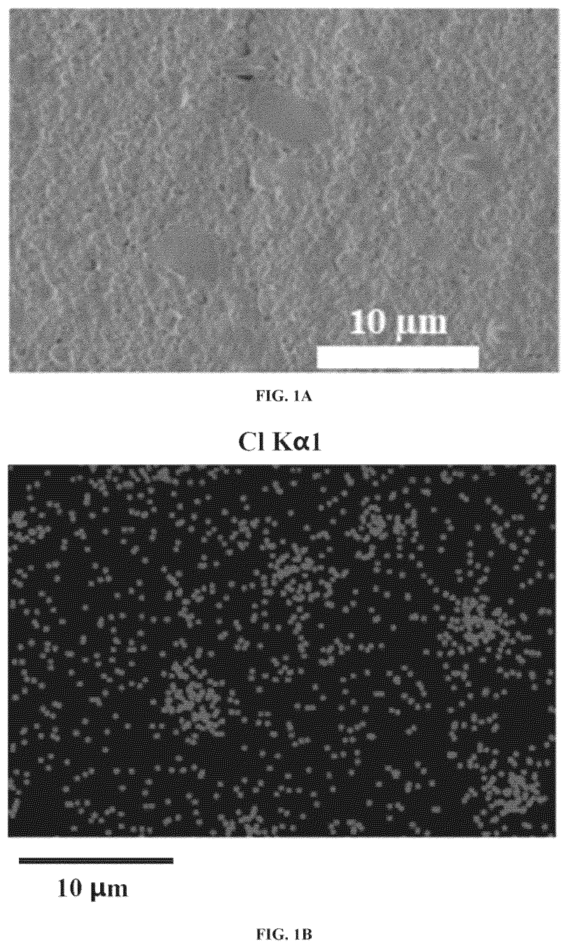

The test results are shown in FIGS. 1 to 6.

As shown in FIGS. 1A and 1B, the drug-aggregated thermoplastic vulcanizate prepared in Example 1 exhibits a sea-island structure, where the dispersed rubber phase has a size substantially in the range from 2 μm to 10 μm and presents an irregular ellipsoidal morphology. HDPE, EVA, antioxidant 1010, and anti-aging agent 4010NA all contain no chlorine element, while IMI contains a certain amount of chlorine. Element scanning of the entire cross-section of the material reveals that the chlorine in IMI is mainly concentrated in the dispersed EVA rubber phase. The results demonstrate that the IMI is preliminarily wrapped with the dispersed EVA phase.

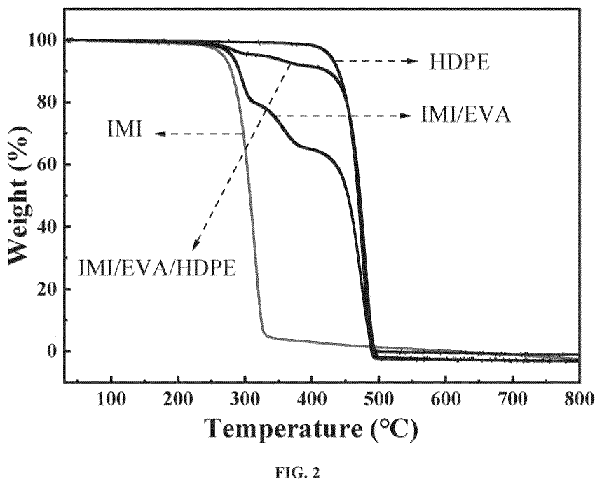

As shown in FIG. 2, the initial decomposition temperature of IMI is 240° C. The thermogravimetric curves of IMI/EVA and IMI/EVA/HDPE composites both exhibit three stages. The first thermal decomposition stage in both composites is attributed to the decomposition of IMI in the composites. The second and third thermal weight loss stages in the IMI/EVA composite are attributed to the decomposition of EVA, while the second and third thermal weight loss stages in the IMI/EVA/HDPE composite are attributed to the decomposition of EVA and HDPE. The initial decomposition temperature of IMI/EVA and IMI/EVA/HDPE each is 258° C. The increase in the initial decomposition temperature is attributed to encapsulation of IMI with EVA, which reduces partial heat transfer.

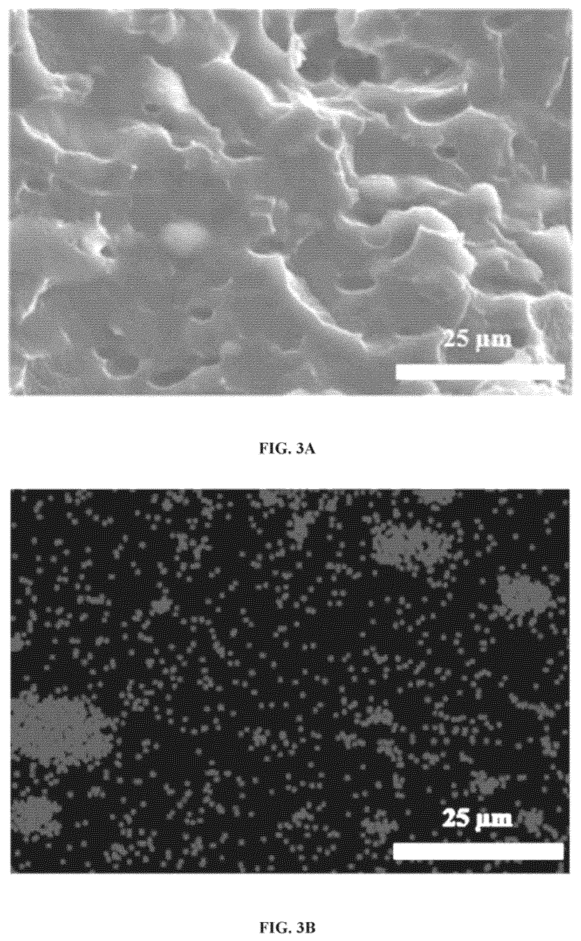

FIG. 3A shows an SEM image of the IMI/silicone rubber/high-density polyethylene prepared in Example 4. FIG. 3B shows an EDS mapping of chlorine in the composite material prepared in Example 4. It can be seen from the microscopic image of the composite material that the microscopic cross-section of the prepared material exhibits a sea-island structure, with the island phase of silicone rubber having a particle size ranging from 10 μm to 20 μm. The EDS mapping of chlorine shows that I MI exhibits an aggregated distribution. However, overall, it can be seen that in the same region, the area of island phase of silicone rubber in the SEM image is more than the chlorine-aggregated area in the EDS mapping, revealing that part of IMI is wrapped while another part of IMI diffuses into the HDPE matrix.

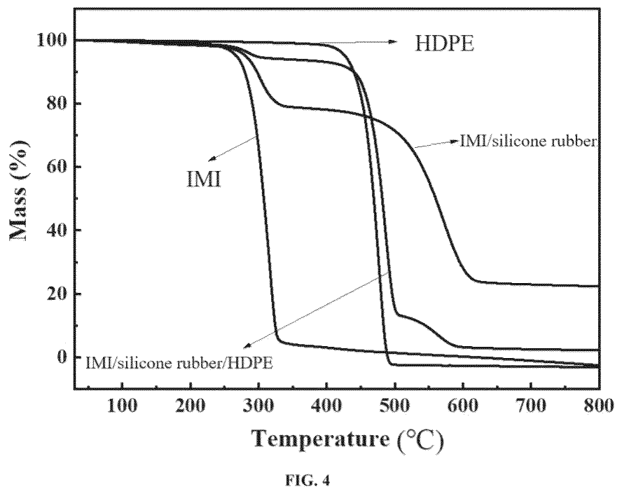

FIG. 4 shows a thermogravimetric curve diagram of the IMI/silicone rubber/high-density polyethylene prepared in Example 4. The initial decomposition temperature of IMI is 240° C. The thermogravimetric curve of the IMI/silicone rubber/high-density polyethylene exhibits three thermal weight loss stages, with the first stage corresponding to the thermal decomposition of IMI. Apparently, the decomposition temperature of IMI in the composite material is significantly higher than that of pure IMI.

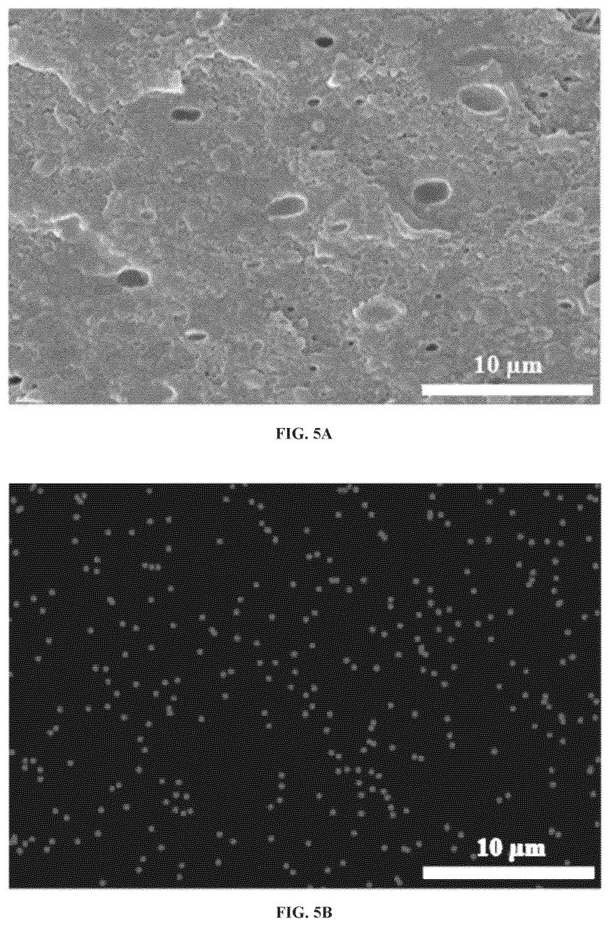

FIG. 5A shows an SEM image of the composite material prepared in Comparative Example 1. FIG. 5B shows an EDS mapping of the composite material prepared in Comparative Example 1. From FIGS. 5A and 5B, it can be seen that when the pesticide is directly mixed with the resin by the conventional method, chlorine elements are uniformly distributed, indicating that IMI is uniformly dispersed throughout HDPE and is susceptible to environmental influences.

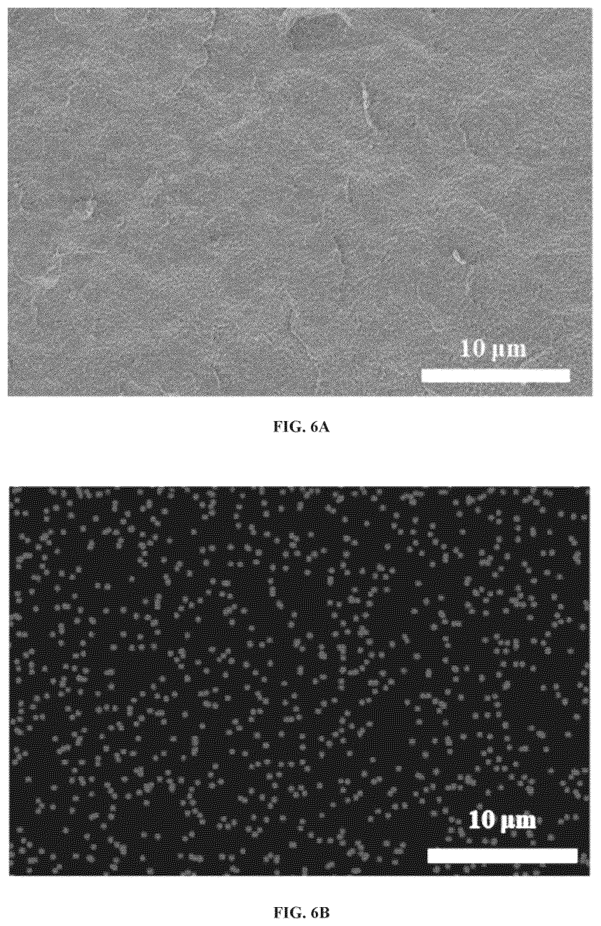

FIG. 6A shows an SEM image of the composite material prepared in Comparative Example 2. FIG. 6B shows an EDS mapping of the composite material prepared in Comparative Example 2. FIGS. 6A and 6B reveal that without the addition of a crosslinking agent, chlorine elements are uniformly distributed, indicating that IMI is not aggregated in the EVA island phase but uniformly dispersed in HDPE.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present application.

The above-described embodiments are only several implementations of the present application, and the descriptions are relatively specific and detailed, but they should not be construed as limiting the scope of the present application. It should be understood by those of ordinary skill in the art that various modifications and improvements can be made without departing from the concept of the present application, and all fall within the protection scope of the present application. Therefore, the patent protection of the present application shall be defined by the appended claims.

What is claimed is:

1. A thermoplastic vulcanizate, comprising following raw materials in parts by weight: 8 parts to 40 parts of a heat-resistant rubber, 60 parts to 90 parts of a plastic, 1 part to 6 parts of an ant-repellent agent, and 0.1 parts to 3 parts of a vulcanizing agent.

2. The thermoplastic vulcanizate according to claim 1, wherein the heat-resistant rubber is selected from the group consisting of ethylene-vinyl acetate rubber, silicone rubber, acrylate rubber, hydrogenated acrylonitrile-butadiene rubber, acrylonitrile-butadiene rubber, chlorinated polyethylene rubber, ethylene-propylene-diene rubber, and any combination thereof.

3. The thermoplastic vulcanizate according to claim 1, wherein the plastic is selected from the group consisting of high-density polyethylene, low-density polyethylene, polypropylene, polyvinylidene fluoride, polyvinyl chloride, and any combination thereof.

4. The thermoplastic vulcanizate according to claim 1, wherein the ant-repellent agent is selected from the group consisting of imidacloprid, bifenthrin, abamectin, thiamethoxam, cypermethrin, chlorpyrifos, fipronil, and any combination thereof.

5. The thermoplastic vulcanizate according to claim 1, wherein the vulcanizing agent is selected from the group consisting of dicumyl peroxide, 2,5-dimethyl-2,5-di(tert-butylperoxy)hexane, sulfur, silane coupling agent, trithiocyanuric acid, 2,4-dichlorobenzoyl peroxide, tert-butyl peroxybenzoate, and any combination thereof.

6. The thermoplastic vulcanizate according to claim 1, wherein the thermoplastic vulcanizate further comprises an antioxidant, an anti-aging agent, or a combination of the antioxidant and the anti-aging agent.

7. The thermoplastic vulcanizate according to claim 6, wherein the thermoplastic vulcanizate comprises following raw materials in parts by weight: 8 parts to 40 parts of the heat-resistant rubber, 60 parts to 90 parts of the plastic, 1 part to 6 parts of the ant-repellent agent, 0.1 parts to 3 parts of the vulcanizing agent, 0.1 parts to 0.5 parts of the antioxidant, and 0.5 parts to 1 part of the anti-aging agent.

8. The thermoplastic vulcanizate according to claim 6, wherein the antioxidant is selected from the group consisting of antioxidant 1010, antioxidant 264, antioxidant 168, antioxidant 1067, and any combination thereof.

9. The thermoplastic vulcanizate according to claim 6, wherein the anti-aging agent is selected from the group consisting of anti-aging agent 4010NA, anti-aging agent ODA, anti-aging agent 264, and any combination thereof.

10. A method for preparing the thermoplastic vulcanizate according to claim 1, comprising following steps:
mixing the heat-resistant rubber, the ant-repellent agent, and the vulcanizing agent to obtain a premix;
blending the premix with the plastic to obtain a rubber-plastic mixture; and
subjecting the rubber-plastic mixture to dynamic vulcanization.

11. The method according to claim 10, wherein the dynamic vulcanization satisfies at least one of following conditions:
(1) a temperature is in a range from 160° C. to 230° C.;
(2) a rotation speed is in a range from 30 rpm to 90 rpm; and
(3) a time period is in a range from 5 minutes to 10 minutes.

12. An insect-repellent and insecticidal chemical product, comprising the thermoplastic vulcanizate according to claim 1 as a raw material.

13. A cable, comprising a cable body and the insect-repellent and insecticidal chemical product according to claim 9 adhered to a surface of the cable body.
